(19) United States
(12) Patent Application Publication
(10) Pub. No.: US 2023/0063815 A1
(43) Pub. Date: Mar. 2, 2023

(54) AEROSOL-GENERATING ARTICLE AND AEROSOL-GENERATING SYSTEM COMPRISING THE SAME

(71) Applicant: Shenzhen Eigate Technology Co., Ltd., Shenzhen (CN)

(72) Inventor: Tuanfang LIU, Shenzhen (CN)

(21) Appl. No.: 17/693,399

(22) Filed: Mar. 13, 2022

(30) Foreign Application Priority Data
Aug. 26, 2021 (CN) 202110985887.4
Aug. 26, 2021 (CN) 202122025332.3

(51) Int. Cl. A24D 1/20; A24F 40/465; A24F 40/20; H05B 6/10

(52) U.S. Cl. CPC A24D 1/20; A24F 40/465; A24F 40/20; H05B 6/105

(57) ABSTRACT

An aerosol-generating article includes a heating element and a tobacco material. The heating element is wrapped in the tobacco material, or the tobacco material is wrapped in the heating element, or the heating element is disposed in the tobacco material.

### CROSS-REFERENCE TO RELATED APPLICATIONS

Pursuant to 35 U.S.C. § 119 and the Paris Convention Treaty, this application claims foreign priority to Chinese Patent Application No. 202110985887.4 filed Aug. 26, 2021, and to Chinese Patent Application No. 202122025332.3 filed Aug. 26, 2021. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, Mass. 02142.

### BACKGROUND

The disclosure relates to an aerosol-generating article and an aerosol-generating system comprising the same.

Conventional smoking devices include a heating element in the shape of a sheet or a rod. In use, the heating element is inserted into the tobacco material and the tobacco material is heated. The direct contact between the heating element and the tobacco material may result in unintended overheating and/or burning of the tobacco material, which may adversely affect the taste of the tobacco smoke.

### SUMMARY

The first objective of the disclosure is to provide an aerosol-generating article; the aerosol-generating article comprises a heating element and a tobacco material; the heating element is wrapped in the tobacco material, or the tobacco material is wrapped in the heating element, or the heating element is disposed in the tobacco material; the tobacco material of the aerosol-generating article is heated through high-frequency electromagnetic induction; and the heating element fully contacts with the tobacco material to provide a uniform heating throughout the tobacco material, thus improving the taste of tobacco smoke.

In a class of this embodiment, the heating element comprises a conductive metal or is coated with a conductive metal layer; and the conductive metal includes, but is not limited to, copper, silver, gold, aluminum, and tungsten.

In a class of this embodiment, the heating element is in the shape of a tube, a film, a sheet, a powder, or a combination thereof; and the tobacco material is solid, liquid, or semisolid.

In a class of this embodiment, the tobacco material is solid in the shape of a sheet, a filament, a powder, or a combination thereof; or the tobacco material is a semi-solid paste or gel.

In a class of this embodiment, the heating element is in the form of a powder and the tobacco material is solid or semisolid; the heating element accounts for 10%-40% by volume of the tobacco material, and preferably 20%-30%; and the heating element is evenly distributed in the tobacco material. When the heating element is greater than 40% by volume of the tobacco material, the temperature for heating the tobacco material is difficult to control; and when the heating element is smaller than 10% by volume of the tobacco material, the tobacco material fails to fully contact with the heating element.

In a class of this embodiment, the heating element is in the shape of a tube; and the tobacco material is disposed in the heating element, thus increasing heating area.

In a class of this embodiment, the heating element is in the shape of a film or a sheet; the heating element is disposed in the tobacco material to divide the tobacco material into parts; preferably, the heating element is formed in a sheet shape to increase the area in contact with the tobacco material, thus providing a uniform heating.

In a class of this embodiment, a plurality of heating elements is disposed in the tobacco material transversely, obliquely, and/or longitudinally, and at least one heating element abutting against the tobacco material comprises a through hole. Specifically, when the plurality of heating elements is disposed in the tobacco material transversely, the tobacco material is blocked by the heating elements, and at least one heating element abutting against the tobacco material comprises the through hole for smoke emission. When the plurality of heating elements is disposed in the tobacco material longitudinally, the tobacco material is not blocked, and the through hole is not necessary. When the plurality of heating elements is disposed in the tobacco material obliquely, the through hole is disposed according to whether the tobacco material is blocked. In summary, the at least one through hole is disposed on the heating element as needed for smoke emission.

In a class of this embodiment, the aerosol-generating article further comprises a main body comprising a cavity; the heating element and the tobacco material is disposed in the cavity; one end of the main body comprises a mouthpiece portion; the main body comprises paper, glass, or quartz; and preferably, the main body is made of paper to simulate conventional cigarette packaging, thus offering advantages such as easy processing and low cost.

The second objective of the disclosure is to provide an aerosol-generating system comprising the aerosol-generating article and a power supply; the power supply comprises a chamber and a coil; the aerosol-generating article and the coil are disposed in the chamber; and the coil is configured to produce an electromagnetic field and induce an electric current in the heating element placed in the electromagnetic field, causing the heating element to produce heat.

The following advantages are associated with the aerosol-generating article and the aerosol-generating system of the disclosure: during assembly, the heating element fully contacts with the tobacco material and provides heat through high-frequency electromagnetic induction, thus increasing the heating area, providing a uniform heating throughout the tobacco material, and improving the taste of the tobacco smoke.

### BRIEF DESCRIPTION OF THE DRAWINGS

FIG. 1 is an exploded view of a power supply of an aerosol-generating system according to one example of the disclosure;

FIG. 2 is a cross-sectional view of a power supply of an aerosol-generating system according to one example of the disclosure;

FIG. 3 is a cross-sectional view of an aerosol-generating article according to Example 1 of the disclosure;

FIG. 4 is a cross-sectional view of an aerosol-generating article according to Example 3 of the disclosure; and

FIG. 5 is a cross-sectional view of an aerosol-generating article according to Example 4 of the disclosure.

In the drawings, the following reference numbers are used: 1. Mouthpiece assembly; 3. Cover; 4. Coil; 5. High-frequency control board; 6. Battery; 7. Housing; 8. Support frame; 9. Button bracket; 101. Mouthpiece; 201. Tobacco material; 202. Heating element; 203. Fourth cavity; 301. Recess; 302. Third opening; 303. Tube; 304. Third cavity; 401. Hollow space; 701. First cavity; and 901. Power button.

### DETAILED DESCRIPTION

To further illustrate the disclosure, embodiments detailing an aerosol-generating article and an aerosol-generating system comprising the same are described below. It should be noted that the following embodiments are intended to describe and not to limit the disclosure.

As used herein, the term “tobacco material” refer to aerosol-generating substances that can be heated or burned to produce odors, and/or nicotine, and/or smoke. The tobacco material may be solid, liquid, or semisolid. The solid tobacco material is usually processed into tobacco flakes to achieve high air permeability, or allow convenient assembly and easy preparation. The aerosol-generating substances may be natural or synthetic tobacco material, such as e-liquid, tobacco paste, tobacco flakes, and tobacco leaves. The tobacco material may be enclosed in a shell such as a microcapsule. When heated high enough, the shell tends to degrade or crack, leaking out volatile substances.

The natural tobacco material contains nicotine. Some tobacco material contains aroma substances which can be atomized and inhaled by people to simulate smoking, thus increasing smoker's odds of quitting smoking. In certain examples, the aroma substances comprise peppermint oil. The tobacco material further comprises other additives, such as glycerin and/or propylene glycol.

As used herein, the term “aerosol-generating article” refers to a smoked tobacco product that comprises tobacco material when being heated to generate aerosol, such as smoke and vapor. The aerosol-generating article can neither supply power nor produce an electromagnetic field.

As used herein, the term “power supply” refers to a battery-operated device that can supply power or produce an electromagnetic field.

As used herein, the term “heating element” refers to a component that converts electrical or electromagnetic energy into heat. The heating element can be energized to produce heat. Optionally, the heating element is disposed in an electromagnetic field produced by a coil, so that an electric current is induced by electromagnetic induction and used to heat the heating element.

An aerosol-generating system comprises a power supply comprising a chamber used to hold the aerosol-generating article.

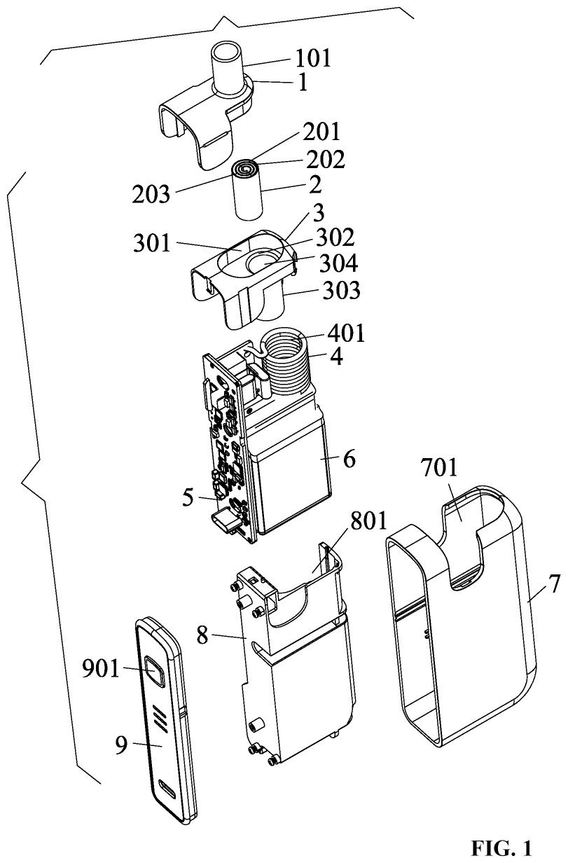

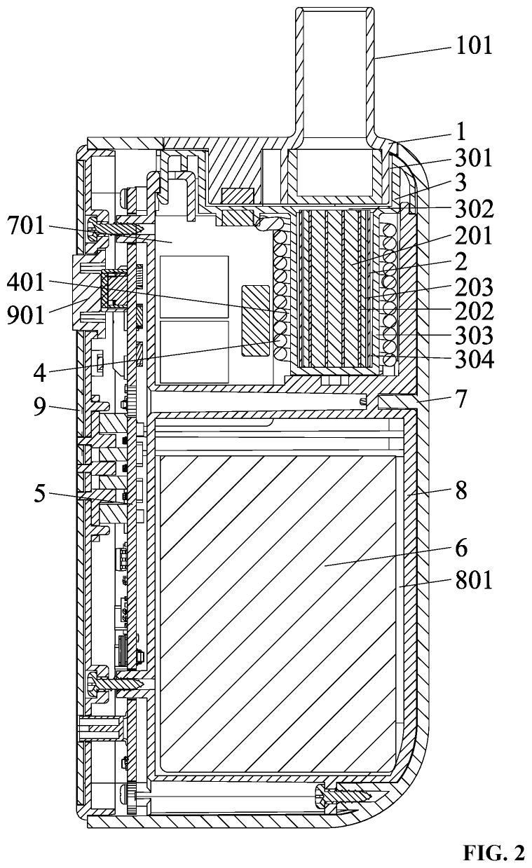

As shown in FIG. 1-2, the power supply comprises a mouthpiece assembly 1, a heating element 202, a cover 3, a coil 4, a high-frequency control board 5, a battery 6, a housing 7, a support frame 8, and a button bracket 9. The output terminal of the battery 6 is soldered to the input terminal of the high-frequency control board 5 so that the battery 6 supplies power to the high-frequency control board 5. The output terminal of the high-frequency control board 5 is soldered to the input terminal of the coil 4 so that the high-frequency control board 5 supplies alternating current to the coil 4. The coil 4 is in the shape of a helix with a hollow space 401. When the alternating current passes through the coil 4, the electromagnetic field is produced in the hollow space 401. The housing 7 comprises a top part and a side part. The top part comprises a first cavity 701 provided with a first opening. The side part comprises a second cavity 801 provided with a second opening. The coil 4, the high-frequency control board 5, and the battery 6 are disposed in the second cavity 801. The support frame 8 is inserted through the first opening into the first cavity 701, and the coil 4 is exposed at the second opening. The cover 3 is disposed in the first cavity 701. The cover 3 comprises a first surface comprising a recess 301. The mouthpiece assembly 1 is fixedly disposed in the recess 301. The recess 301 comprises a bottom wall comprising a third opening 302. The cover 3 further comprises a tube 303 inserted through the third opening 302 into the hollow space 401. The tube 303 is configured to fix the aerosol-generating article. The tube 303 comprises a third cavity 304. The aerosol-generating article is inserted through the third opening 302 into the third cavity 304. The mouthpiece assembly 1 comprises a top portion provided with a mouthpiece 101 for a user to inhale the smoke. The mouthpiece 101 is formed integrally with the mouthpiece assembly 1. The mouthpiece assembly 1 is fixedly disposed on the cover 3 so that the mouthpiece 101 communicates with the third cavity 304 for smoke emission. The button bracket 9 is disposed on one side of the housing 7. The button bracket 9 comprises a power button 901 disposed opposite to the high-frequency control board 5. When the power button is pressed, the high-frequency control board 5 is turned on or off. When the alternating current passes through the coil 4, the electromagnetic field is produced in the hollow space 401, allowing for a dense charge on the surface of the heating element 3. The dense charge results in collision between atoms in which kinetic energy is used to generate heat.

To further illustrate the disclosure, embodiments detailing the aerosol-generating article are described below. It should be noted that the following embodiments are intended to describe and not to limit the disclosure.

### Example 1

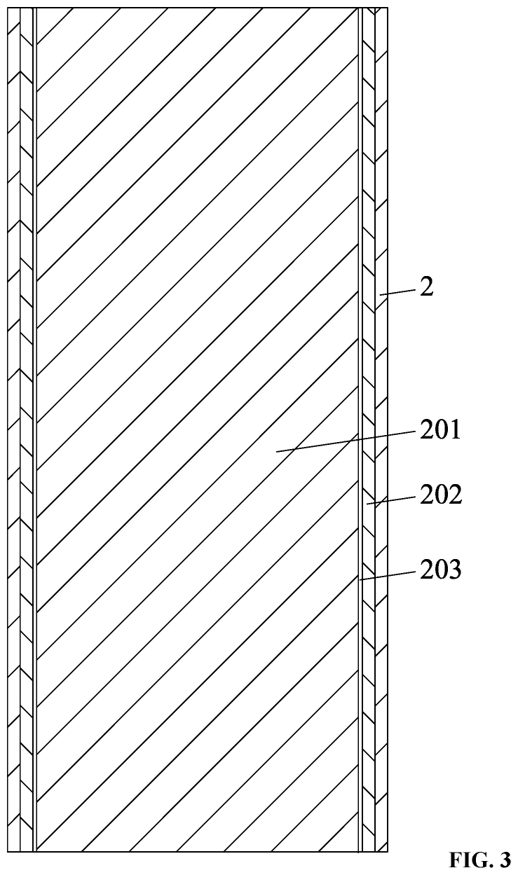

As shown in FIG. 3, the aerosol-generating article comprises a main body 2 and a mouthpiece portion. The main body 2 comprises a side wall and a fourth cavity 203 defined by the side wall. The tobacco material 201 and the heating element 202 are disposed in the fourth cavity 203. The heating element 202 is in the shape of a tube and is electroplated or pasted on the inner surface of the side wall. The tobacco material is disposed in the heating element 202. The wall of the heating element is continuous or discontinuous. Optionally, the heating element 202 comprises a tube wall in the shape of a mesh.

### Example 2

A second example of the aerosol-generating article is similar to the Example 1, except for the following differences: the aerosol-generating article comprises a tube-shaped heating element 202 instead of the main body 2; and tube-shaped heating element 202 is filled with the tobacco material 201.

### Example 3

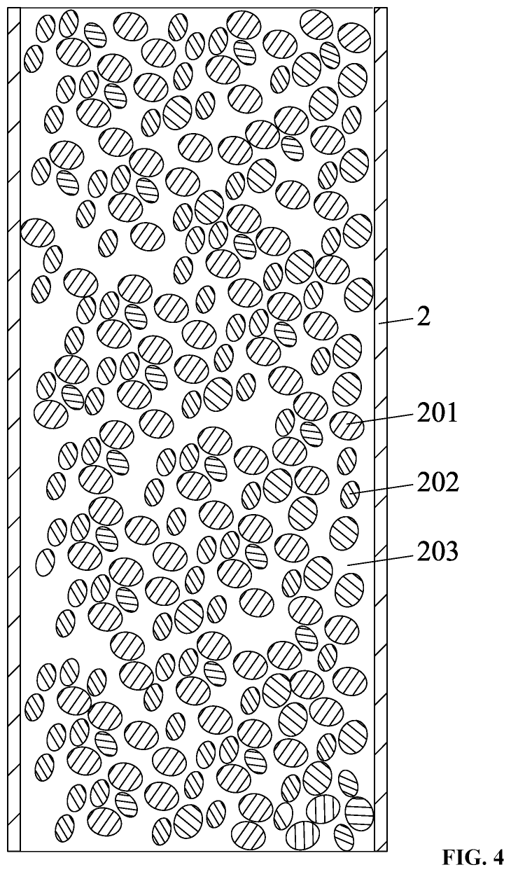

As shown in FIG. 4, the aerosol-generating article comprises a main body 2 and a mouthpiece portion. The main body 2 comprises a side wall and a fourth cavity 203 defined by the side wall. The tobacco material 201 and the heating element 202 are disposed in the fourth cavity 203. The heating element 202 is in the form of a powder. The tobacco material is solid or semisolid. The heating element 202 is uniformly mixed with the tobacco material. The heating element accounts for 10%-40% by volume of the tobacco material, and preferably 20%-30%.

### Example 4

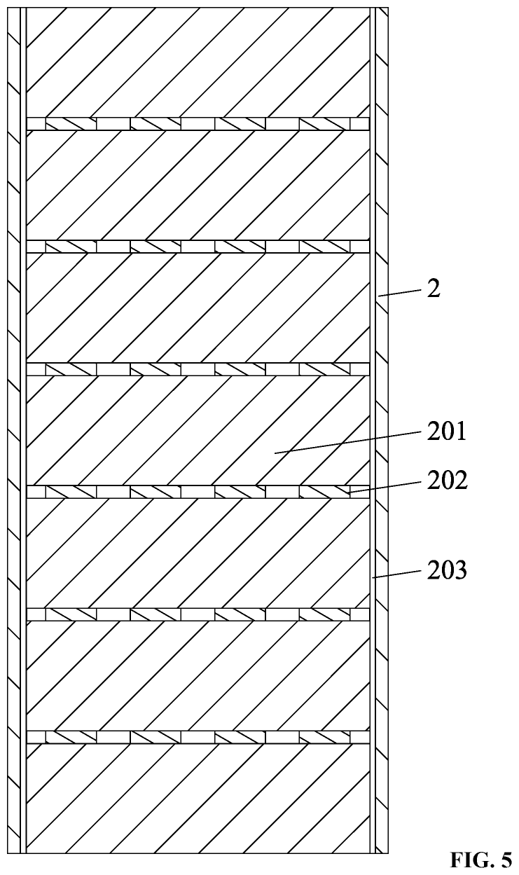

As shown in FIG. 5, the aerosol-generating article comprises a main body 2 and a mouthpiece portion. The main body 2 comprises a side wall and a fourth cavity 203 defined by the side wall. The tobacco material 201 and the heating element 202 are disposed in the fourth cavity 203. The aerosol-generating article comprises at least one heating element 202 in the shape of a film or a sheet. The number of at least one heating element 202 is determined by demand. Preferably,

a plurality of heating elements 202 is disposed in the tobacco material 201 transversely, optionally, obliquely or longitudinally, to divide the tobacco material into parts and the tobacco material is located between every two heating elements. Each heating element comprises a through hole for smoke emission. In certain examples, the plurality of heating elements 202 is disposed in the tobacco material longitudinally, the tobacco material 201 is not blocked, and the through hole is not necessary. In certain examples, the plurality of heating elements 202 is disposed in the tobacco material 201 obliquely, if the tobacco material is unblocked, the through hole is not necessary; if the tobacco material is blocked, the through hole is disposed.

It will be obvious to those skilled in the art that changes and modifications may be made, and therefore, the aim in the appended claims is to cover all such changes and modifications.

What is claimed is:

1. An aerosol-generating article, comprising a heating element and a tobacco material; wherein the heating element is wrapped in the tobacco material, or the tobacco material is wrapped in the heating element, or the heating element is disposed in the tobacco material.

2. The aerosol-generating article of claim 1, wherein the heating element comprises a conductive metal or is coated with a conductive metal layer.

3. The aerosol-generating article of claim 1, wherein the heating element is in the shape of a tube, a film, a sheet, a powder, or a combination thereof; and the tobacco material is solid, liquid, or semisolid.

4. The aerosol-generating article of claim 3, wherein the tobacco material is solid in the shape of a sheet, a filament, a powder, or a combination thereof; or the tobacco material is a semi-solid paste or gel.

5. The aerosol-generating article of claim 4, wherein the heating element is in the form of a powder and the tobacco material is solid or semisolid; the heating element accounts for 10%-40% by volume of the tobacco material, and the heating element is evenly distributed in the tobacco material.

6. The aerosol-generating article of claim 3, wherein the heating element is in the shape of a tube; and the tobacco material is disposed in the heating element.

7. The aerosol-generating article of claim 3, wherein the heating element is in the shape of a film or a sheet; and the heating element is disposed in the tobacco material to divide the tobacco material into parts.

8. The aerosol-generating article of claim 7, wherein a plurality of heating elements is disposed in the tobacco material transversely, obliquely, and/or longitudinally; and at least one heating element abutting against the tobacco material comprises a through hole.

9. The aerosol-generating article of claim 7, wherein the aerosol-generating article further comprises a main body comprising a cavity; the heating element and the tobacco material is disposed in the cavity; and one end of the main body comprises a mouthpiece portion.

10. An aerosol-generating system comprising the aerosol-generating article of claim 1 and a power supply; wherein the power supply comprises a chamber and a coil; the aerosol-generating article and the coil are disposed in the chamber; and the coil is configured to produce an electromagnetic field and induce an electric current in the heating element placed in the electromagnetic field, causing the heating element to produce heat.
